(19) United States
(12) Patent Application Publication
(10) Pub. No.: US 2014/0372921 A1
(43) Pub. Date: Dec. 18, 2014

(54) SYSTEMS AND METHODS FOR DISPLAY OF A VIDEO CALL IN PICTURE IN PICTURE MODE

(71) Applicant: VONAGE NETWORK LLC, HOLMDEL, NJ (US)

(72) Inventors: Tzahi EFRATI, Hoboken, NJ (US); Adam DEMKO, Tinton Falls, NJ (US)

(21) Appl. No.: 13/919,464

(22) Filed: Jun. 17, 2013

(51) Int. Cl. G06F 3/0484

(52) U.S. Cl. CPC G06F 3/0484
USPC 715/766

(57) ABSTRACT

A system and method for dynamically displaying a video call within the display of another application is disclosed. The system and method includes displaying a first application in a foreground and receiving a request for a video call. The system and method further includes receiving display information associated with the first application and overlaying a display of the video call over a first portion of the foreground, wherein the first portion of the foreground is determined based at least in part upon the display information.

### BACKGROUND OF THE INVENTION

1. Field of the Invention

The present invention generally relates to mobile devices and more particularly to methods for managing a video call in conjunction with another concurrent application.

2. Description of the Related Art

Mobile devices are used for a variety of applications apart from traditional telephony operations such as games or web browsing. Users of such devices prefer not to be confined to a call while engaged in some of these other mobile applications. As such, many mobile devices are capable of maintaining a voice call while continuing another application. A video call, on the other hand, introduces complications in maintaining both the other activity and the video call at the same time. However, even during a video call users may want to continue to read an article or play a game while continuing the video call.

Accordingly, there is a need for a system and method that can automatically place the video call image in a portion the display of a concurrently running application that does not obstruct the usable display area of the application so that both the video call and the application can continue to operate and be displayed.

### SUMMARY OF THE INVENTION

A system and method for dynamically displaying a video call within the display of another application is disclosed. The system and method includes displaying a first application in a foreground and receiving a request for a video call. The system and method further includes receiving display information associated with the first application and overlaying a display of the video call over a first portion of the foreground, wherein the first portion of the foreground is determined based at least in part upon the display information.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of an exemplary communication network in accordance with one or more embodiments of the invention;

FIG. 2 is an illustration of an exemplary display of a video call and a concurrent application appearing on a user device in accordance with one or more exemplary embodiments of the invention;

FIG. 3 is a block diagram of exemplary elements of a user device in accordance with one or more embodiments of the invention;

FIG. 4 is a flow diagram of a method for displaying a video call and concurrent application in accordance with embodiments of the invention; and

FIG. 5 is a flow diagram of a method for displaying a video call and concurrent application in accordance with embodiments of the invention in which the video call is executed prior to the concurrent application.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

In the following description, references are made to a telephony device. The term “telephony device” or “communication device” is intended to encompass any type of device capable of acting as a telephony device. This includes a traditional analog telephone, an Internet Protocol (IP) telephone, a computer running IP telephony software, cellular telephones, mobile telephony devices such as smartphones that can connect to a data network and run software applications, such as the Apple iPhone™, mobile telephony devices running the Android™ operating system, Blackberry™ mobile telephones, and mobile telephones running the Symbian® operating system.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch can interact with an IP telephony system to conduct a telephone call.

The present technology relates to enhancing the experience of users in a video call while concurrently engaged in an alternate application. The video call and application can be implemented within a variety of systems and devices. In the processes described below, the display of a video call can, for example, be implemented at an IP telephony system. The implementation can also be performed using a software application on one or more communication devices.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

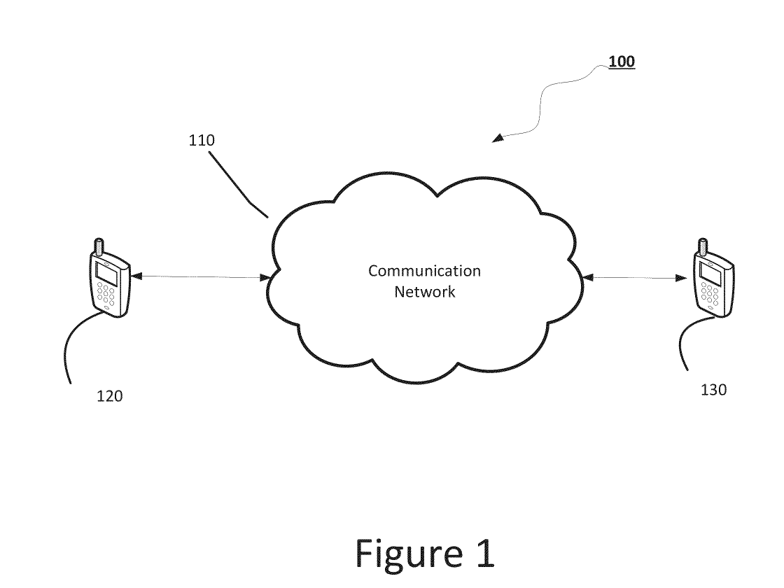

FIG. 1 is an illustration of an exemplary communication network 100 including a communication network 110, a first user device 120 and a second user device 130. The communication network 110 may be one or more networks such as Internet Protocol (IP) networks or public switched telephone networks (PSTN) used to connect the devices. A video call may be established between first user device 120 and second user device 130 through communication network 110.

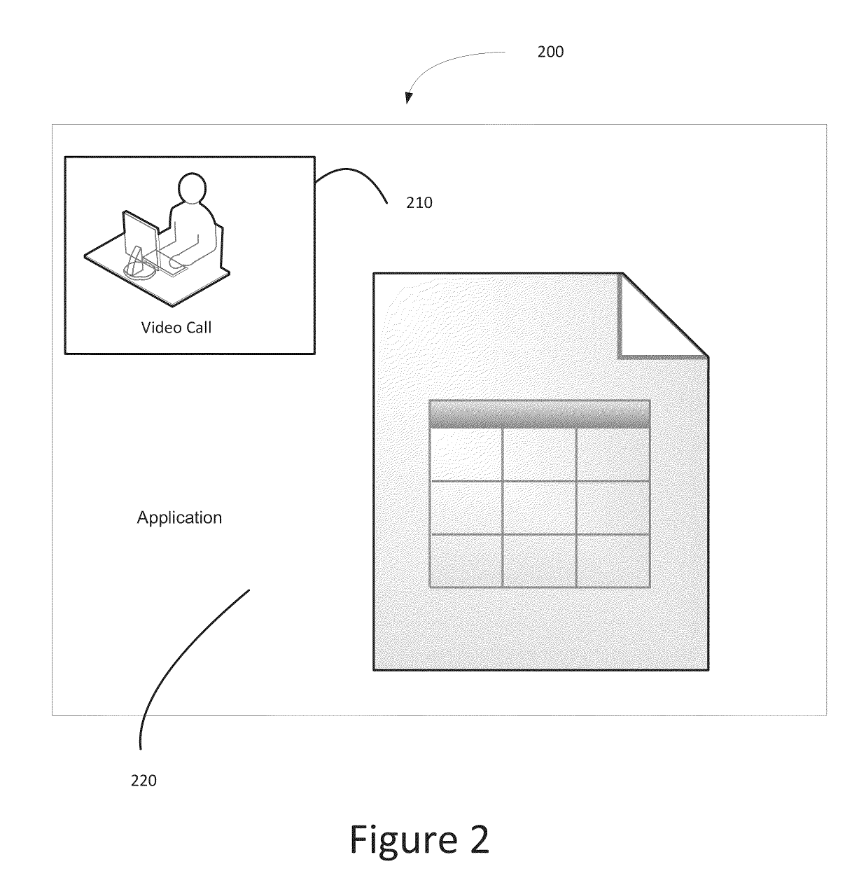

FIG. 2 is an illustration of an exemplary mobile device display 200 on first user device 120 of the video call between first user 120 and second user 130. The display 200 includes a video call display window 210 and an application 220.

In some embodiments the video call display window 210 may include command buttons displayed with the video call for controlling the operations of the video call. The controls may include “connect,” “end call,” volume controls and the like. In some embodiments the command buttons may be hidden when not in use so as not to interfere with the video call display.

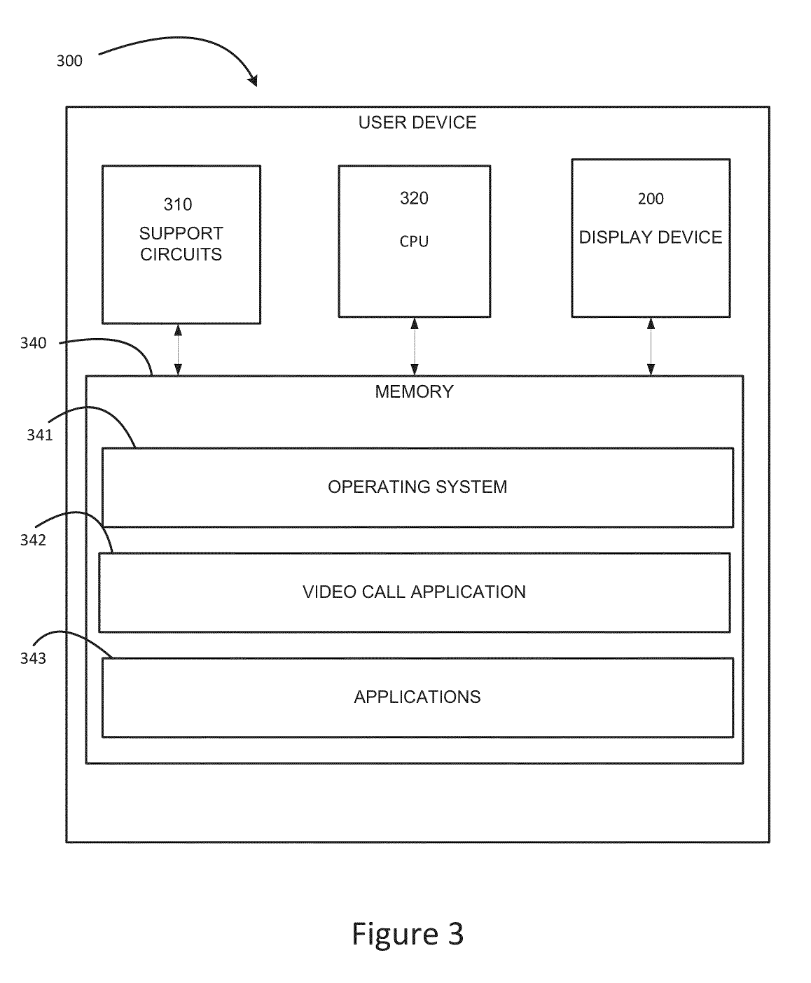

FIG. 3 depicts a block diagram of exemplary elements of a user device 300 (i.e. 120 and 130) for displaying a video call concurrently with another application according to one or more embodiments. The user device 300 comprises a Central Processing Unit (CPU) 320, support circuits 310, a memory 340, and the display device 200. The CPU 320 may comprise one or more commercially available microprocessors or microcontrollers that facilitate data processing and storage. The various support circuits 310 facilitate the operation of the CPU 320 and include one or more clock circuits, power supplies, cache, input/output circuits, and the like. The memory 340 comprises at least one of Read Only Memory (ROM), Random Access Memory (RAM), disk drive storage, optical storage, flash memory or any other form of digital storage, local or remote, and is preferably of non-volatile nature. In some embodiments, the display device 200 may be a touch screen able to accept input from a user's finger or input from a stylus. In some embodiments, the memory 340 comprises an operating system 341, video call application 342 and other applications 343 (i.e. browsers, games, video players and other applications) including application 220.

A computer program or software routine, such as video call application 342 and applications 343, when executed by the CPU 320, causes the user device 300 to perform processes of the disclosed embodiments, and is generally stored in memory 340. Also, the software routines could also be stored remotely from the CPU 320. For example, the software could be resident on servers and memory devices that are located remotely from the CPU 320, but which are accessible to the CPU 320 via a data network connection.

Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine of the disclosed embodiments is capable of being executed on any computer operating system, and is capable of being performed using any CPU architecture.

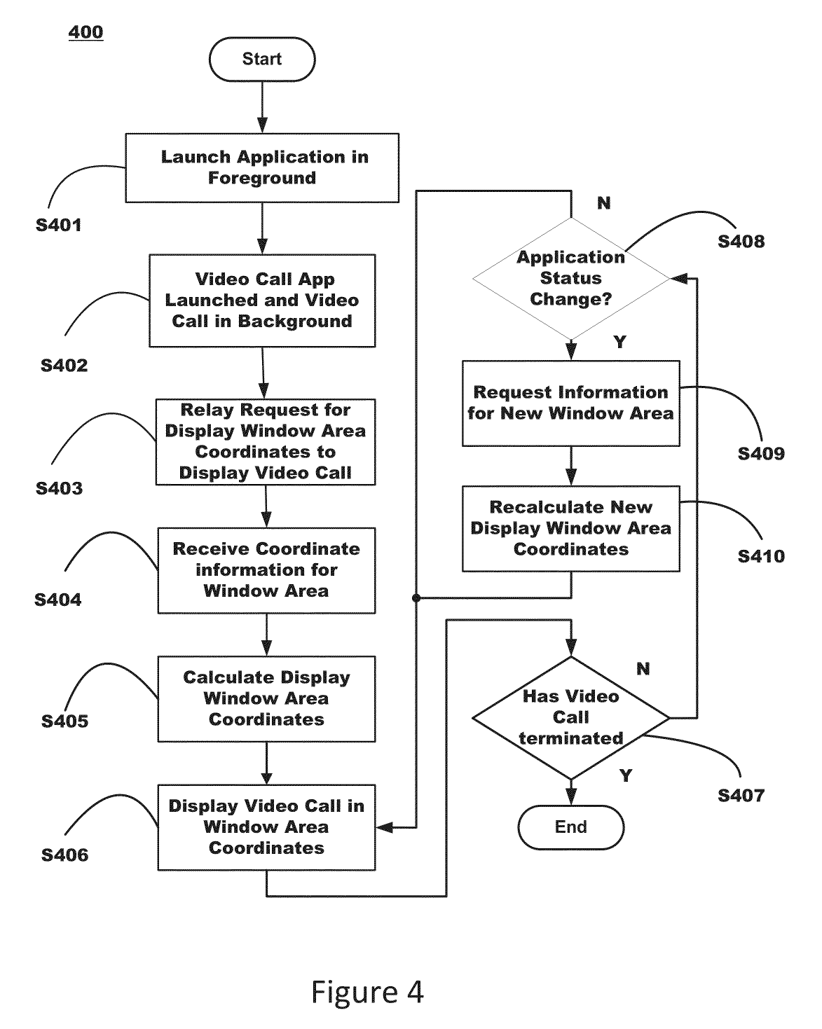

FIG. 4 is a flow diagram of a method 400 for displaying a video call and a concurrent application in accordance with embodiments of the invention. The method starts at step S401 when the operating system 341 launches application 220 in the foreground of display device 200 on user device 300. The application 220 may be any application enabled to run on a mobile device such as, a game, a video, a browser, a document and the like.

At step S402, while the application 220 continues to run in the foreground of display device 200, operating system 341 launches video application 342 when a video call is received and operating system 341 places video application 342 in the background. At step S402 operating system 341 maintains the video call application 342 in the background and informs video call application 342 that application 220 is currently running in the foreground of display device 200.

At step S403, operating system 341 relays a request from the video call application 342 to the current application 220 requesting coordinates of a display area for video call display window 210 to display video call application 342 on display device 200.

At step S404, the operating system 341 receives information from current application 220 for the display area that the current application 220 determines will not obstruct a usable display area of application 220. The usable display area of an application is that area necessary for a user to view the actions of an application in order to properly interact with the application. For example, if application 220 is a game, the video call display window 210 would preferably not obstruct the playing area of the game. For instance, if the video game requires the players to shoot a target it would be difficult to continue the game if the video call display window 210 obstructs the view of the target.

At step S405, the operating system 341 uses the information for the display area from current application 220 from step S404 to calculate coordinates for video call display window 210.

At step S406, the operating system 341 displays video call application 342 in the video call display window 210 while the application 220 continues to run in the foreground. The user is enabled to continue the application 220 and participate in the video call through the video call display window 210 concurrently running on user device 300.

At step S407, operating system 341 will determine if the video call has terminated. If operating system 341 determines that the video call has terminated the application 220 will be restored to the full display of display device 200 and the video call application 342 and video call display window 210 will close.

If the video call has not terminated, operating system 341 continues to monitor video call application 342 and current application 220 for any changes in a status of application 220 that may require a new usable display area and, thus, a location change of video call display window 210. A location change may be necessary so that video call display window 210 continues to avoid obstructing application 220 as the status of application 220 changes.

At step S408, operating system 341 will determine if there is any change in status requiring a change to the display area needed by application 220. If not, the process returns to step S406 and the video call application 342 remains displayed in the coordinates for video call display window 210 as calculated in step S405.

If the status of application 220 has changed, at step S409 operating system 341 requests information from current application 220 for the display area that the current application 220 determines will not obstruct the usable display area of application 220.

At step S410, operating system 341 recalculates the appropriate coordinates of an area of display that will not obstruct the usable area of application 220.

The process continues by returning to step S406 for displaying the video call application 342 in video call display window 210. The application 220 and the video call application 342 continue to run concurrently until it is determined that the video call has ended at step S407.

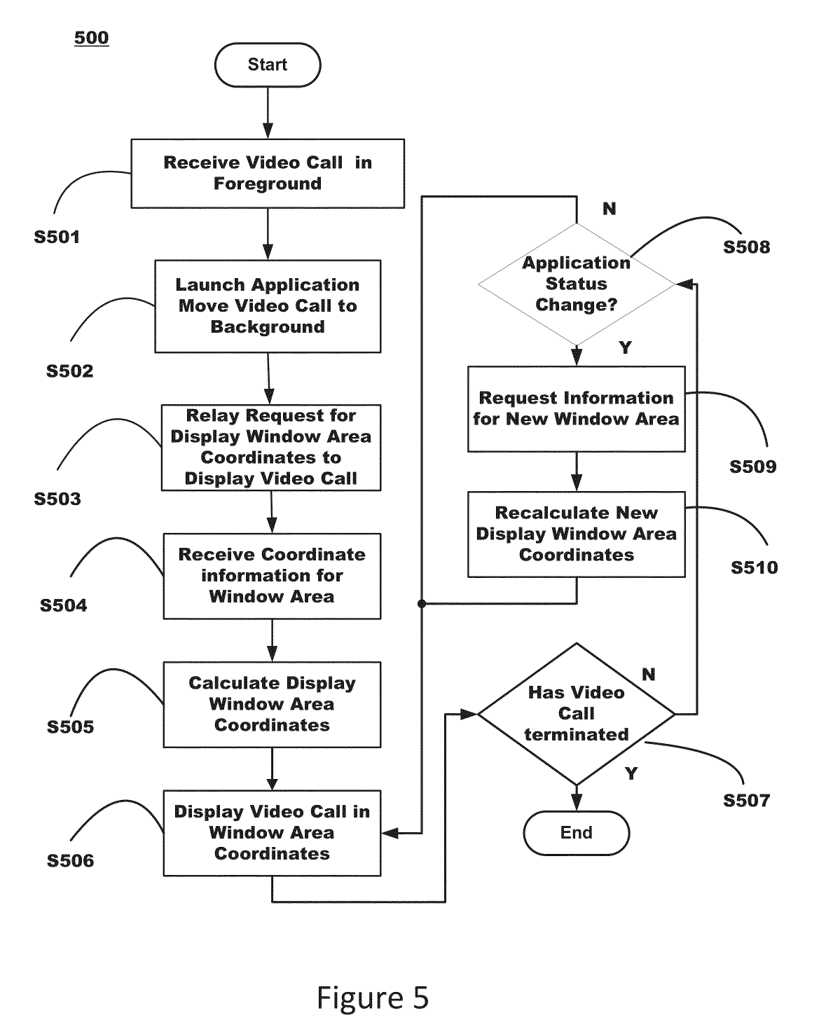

FIG. 5 is a flow diagram of a method 500 for displaying a video call and a concurrent application in accordance with embodiments of the invention in which the video call application is launched prior to the application 220. The method starts at step S501 with the operating system 341 launching a video call application 342. The video call application 342 may be launched as a result of a video call received at the user device 300 or may be a result of a video call initiated at the user device 300.

At step S502, operating system 341 launches application 220 on user device 300. The application 220 may be any application enabled to run on a mobile device including, a game, a video, a browser, a document or the like. Operating system 341 gives application 220 priority for display device 200 and the video call application 342 is sent to the background. The operating system 341 informs video call application 342 that application 220 is now running in the foreground of display device 200.

At step S503, in order for the video call application 342 to continue to be displayed concurrently with the application 320, operating system 341 relays a request from the video call application 342 to the current application 220 requesting coordinates of a display area for video call display window 210 to display video call application 342 on display device 200.

At step S504, the operating system 341 uses the information for the display area from current application 220 from step S504 to calculate coordinates for video call display window 210.

At step S505, the application 220 sends and the video call receives the appropriate display area coordinates for video call display window 210 from application 120.

At step S506, the operating system 341 displays video call application 342 in the video call display window 210 while the application 220 continues to run. The user is enabled to continue the application 220 and participate in the video call through the video call display window 210 concurrently running on user device 300.

At step S507, operating system 341 will determine if the video call has terminated. If operating system 341 determines that the video call has terminated the application 220 will be restored to the full display of display device 200 and the video call application 342 and video call display window 210 will close.

If the video call has not terminated, operating system 341 continues to monitor video call application 342 and current application 220 for any changes in a status of application 220 that may require a new usable display area and, thus, a location change of video call display window 210.

At step S508, operating system 341 determines if there is any change in status requiring a change to the display area needed by application 220. If not, the process returns to step S506 and the video call application 342 remains displayed in the coordinates for video call display window 210 as calculated in step S505.

If the status of application 220 has changed, at step S509 operating system 341 requests information from current application 220 for the display area that the current application 220 determines will not obstruct the usable display area of application 220.

At step S510, operating system 341 recalculates the appropriate coordinates of an area of display that will not obstruct the usable area of application 220.

The process continues by returning to step S506 for displaying the video call application 342 in video call display window 210. The application 220 and the video call application 342 continue to run concurrently until it is determined that the video call has ended at step S507.

In some embodiments the user launches a video call while playing an online game in which the user and the called party are both participants. The user launches the online game as the concurrent application. The user wants to continue to see the called party while playing the game.

In some embodiments the user launches a video call and a news site. The user wants to see a news article from a website through a browser, for example, while continuing the call. Thus, the user is able to discuss the article with the called party.

In some embodiments of the invention, the user launches a video call and a streaming video of a football game, for example. The user wants to watch the game and continue the call.

The embodiments discussed and figures presented are meant only as examples to illustrate the embodiments of the invention and are not intended as a limitation of the invention. Many variations may be employed in embodiments of the invention.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for overlaying the display of a video call over the display of an application comprising:
displaying a first application in a foreground;
receiving a request for a video call;
receiving display information associated with the first application; and
overlaying a display of the video call over a first portion of the foreground, wherein the first portion of the foreground is determined based at least in part upon the display information.

2. The method of claim 1, wherein the display information indicates a usable display area.

3. The method of claim 1, further comprising:
receiving updated display information; and
moving the display of the video call to a second portion of the foreground, wherein the second portion of the foreground is determined based at least in part upon the updated display information.

4. The method of claim 3, wherein the updated display information is associated with the first application.

5. The method of claim 3, wherein the updated display information is associated with a second application.

6. The method of claim 1, wherein the first application comprises a game, a video player, a browser or a document display application.

7. The method of claim 1, wherein receiving the request for the video call occurs subsequent to displaying the first application in the foreground.

8. A system for dynamically displaying a video call within the display of an application comprising:
a mobile device;
an operating system on the mobile device; and
a display on the mobile device,
wherein the operating system is configured to:
display a first application in a foreground;
receive a request for a video call;
receive display information associated with the first application; and
overlay a display of the video call over a first portion of the foreground, wherein the first portion of the foreground is determined based at least in part upon the display information.
